(19) United States
(12) Patent Application Publication
(10) Pub. No.: US 2021/0320429 A1
(43) Pub. Date: Oct. 14, 2021

(54) COMMUNICATION DEVICE

(71) Applicant: Murata Manufacturing Co., Ltd., Kyoto (JP)

(72) Inventors: Keisei TAKAYAMA, Kyoto (JP); Kengo ONAKA, Kyoto (JP); Hirotsugu MORI, Kyoto (JP)

(21) Appl. No.: 17/358,649

(22) Filed: Jun. 25, 2021

Related U.S. Application Data
(63) Continuation of application No. PCT/JP2019/051499, filed on Dec. 27, 2019.

(30) Foreign Application Priority Data
Dec. 28, 2018 (JP) 2018-247837

(51) Int. Cl. H01Q 21/06; H01Q 9/04; H01Q 5/48; H01Q 21/12

(52) U.S. Cl. CPC H01Q 21/065; H01Q 21/12; H01Q 5/48; H01Q 9/0414

(57) ABSTRACT

A communication device includes: an antenna module that radiates a radio wave of a frequency higher than 6 GHz; a mounting substrate to which the antenna module is connected; and a housing that accommodates the mounting substrate. A display screen is formed on a portion of the housing. The housing includes a first surface and a second surface and has a substantially rectangular shape including a first long side, a second long side, a first short side, and a second short side in plan view in a normal direction of the first surface. The display screen is formed on the second surface side. The antenna module is arranged along the first long side of the housing and radiates a radio wave in two directions that are a normal direction of the first surface and a normal direction of a lateral surface along the first long side.

### CROSS REFERENCE TO RELATED APPLICATIONS

This is a continuation of International Application No. PCT/JP2019/051499 filed on Dec. 27, 2019 which claims priority from Japanese Patent Application No. 2018-247837 filed on Dec. 28, 2018. The contents of these applications are incorporated herein by reference in their entireties.

### BACKGROUND OF THE DISCLOSURE

### Field of the Disclosure

The present disclosure relates to a communication device and more specifically relates to an antenna arrangement in a radio communication device.

### Description of the Related Art

Recent years have seen the spread of mobile communication terminal devices having a plate-like shape, namely smartphones and tablets. In such a communication device, a plurality of antennas are sometimes arranged so as to improve communication quality.

Japanese Registered Utility Model No. 3212787 (Patent Document 1) discloses the configuration in which millimeter wave antennas are arranged on four corners of an electronic device (radio communication terminal device) having a rectangular plate-like shape.

Patent Document 1: Japanese Registered Utility Model No. 3212787

### BRIEF SUMMARY OF THE DISCLOSURE

Mobile communication devices are increasingly required to be thinned and to have a larger screen, limiting the room for arranging the antennas inside the devices. On the other hand, mobile communication devices are often operated while being held with user's one hand or both hands, and a radiation direction of an antenna and user's hand overlap with each other depending on user's holding posture. This may cause characteristics deterioration of the antenna.

The present disclosure has been made so as to solve the above-described problem and an object of the present disclosure is to suppress the deterioration of the antenna characteristics, which is caused by user's holding, in a mobile communication terminal device.

A communication device includes: an antenna module that radiates a radio wave of a frequency higher than 6 GHz; a mounting substrate to which the antenna module is connected; and a housing that accommodates the mounting substrate. A display screen is formed on a portion of the housing. The housing includes a first surface and a second surface and has a substantially rectangular shape including a first long side, a second long side, a first short side, and a second short side in plan view in a normal direction of the first surface. The display screen is formed on the second surface side. The antenna module is arranged along the first long side of the housing and is configured to radiate a radio wave in two directions that are a normal direction of the first surface and a normal direction of a lateral surface along the first long side.

According to the communication device of the present disclosure, the antenna module capable of radiating radio waves in two directions is arranged along a long side of the communication device having a rectangular shape. This arrangement reduces the frequency that the radiation directions of radio waves from the antenna overlap with user's hand in either state in which the user holds the communication device with one hand or both hands, being able to suppress the deterioration of the antenna characteristics caused by the user's holding.

### BRIEF DESCRIPTION OF THE SEVERAL VIEWS OF THE DRAWINGS

FIG. 1 is a block diagram of a communication device according to the present embodiment.

Each of FIGS. 2A and 2B is a drawing for explaining the state that a user holds a communication device.

FIG. 3 is a drawing for explaining an antenna-module arrangement in a communication device according to a first embodiment.

FIG. 4 is a perspective view of an antenna module arranged on a mounting substrate.

Each of FIGS. 5A and 5B is a sectional view of the antenna module accommodated in a housing.

Each of FIGS. 6A, 6B and 6C is a sectional view of an antenna module according to a modification.

Each of FIGS. 7A and 7B is a perspective view illustrating another example of an antenna module arranged on a mounting substrate.

Each of FIGS. 8A and 8B is a drawing for explaining an antenna module arrangement in a state in which a communication device is held, in the first embodiment.

Each of FIGS. 9A and 9B is a drawing for explaining an antenna-module arrangement in a communication device according to a second embodiment.

Each of FIGS. 10A and 10B is a drawing for explaining an antenna module arrangement in a state in which the communication device according to the second embodiment is held.

Each of FIGS. 11A, 11B, 11C and 11D is a drawing for explaining an antenna-module arrangement in a communication device according to a third embodiment.

Each of FIGS. 12A and 12B is a drawing for explaining an antenna module arrangement in a state in which the communication device according to the third embodiment is held.

Each of FIGS. 13A and 13B is a drawing for explaining an antenna-module arrangement in a communication device according to a fourth embodiment.

Each of FIGS. 14A and 14B is a drawing for explaining an antenna module arrangement in a state in which the communication device according to the fourth embodiment is held.

Each of FIGS. 15A, 15B, 15C and 15D is a drawing for explaining an antenna-module arrangement in a communication device according to a fifth embodiment.

Each of FIGS. 16A and 16B is a drawing for explaining an antenna module arrangement in a state in which the communication device according to the fifth embodiment is held.

Each of FIGS. 17A, 17B, 17C and 17D is a drawing for explaining an antenna-module arrangement in a communication device according to a sixth embodiment.

Each of FIGS. 18A and 18B is a drawing for explaining an antenna module arrangement in a state in which the communication device according to the sixth embodiment is held.

FIG. 19 is a drawing for explaining an example of an antenna-module arrangement in a communication device according to a seventh embodiment.

Each of FIGS. 20A and 20B is a drawing for explaining an antenna module arrangement in a state in which the communication device according to the seventh embodiment is held.

Each of FIGS. 21A and 21B is a drawing for explaining an example of an antenna-module arrangement in a communication device according to an eighth embodiment.

FIG. 22 is a drawing for explaining an example of an antenna-module arrangement in a communication device according to a ninth embodiment.

FIG. 23 is a sectional view of a first example of the antenna module of FIG. 22.

FIG. 24 is a sectional view of a second example of the antenna module of FIG. 22.

Each of FIGS. 25A and 25B is a drawing for explaining an example of an antenna-module arrangement in a communication device according to a tenth embodiment.

FIG. 26 is a drawing for explaining a modification of an antenna-module arrangement in a communication device according to the tenth embodiment.

FIG. 27 is a drawing for explaining an example of an antenna-module arrangement in a communication device according to an eleventh embodiment.

### DETAILED DESCRIPTION OF THE DISCLOSURE

Embodiments of the present disclosure will be described in detail below with reference to the accompanying drawings. Components that are identical or correspond to each other in the drawings will be provided with an identical reference character and the description thereof will not be repeated.

### (Basic Configuration of Communication Device)

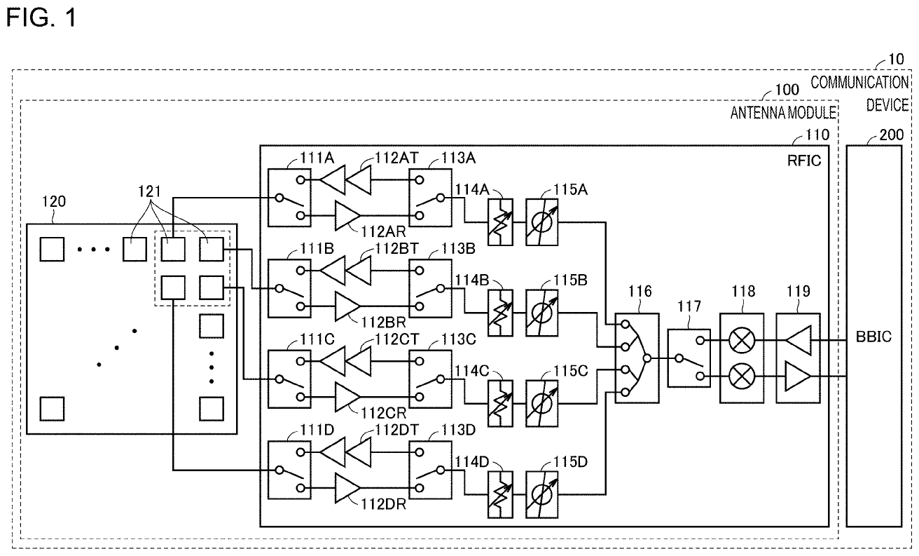

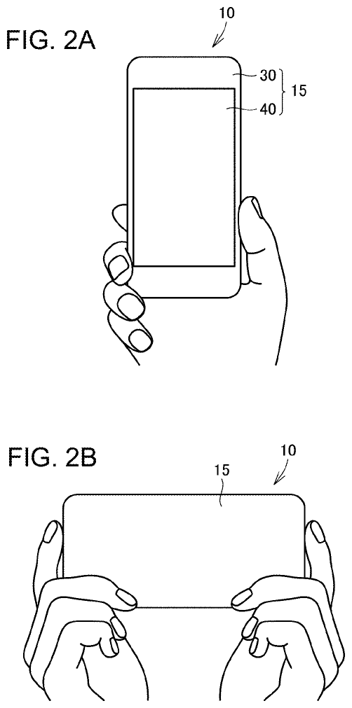

FIG. 1 is an example of a block diagram illustrating a communication device 10 to which an antenna module 100 according to the present embodiment is applied. The communication device 10 is a mobile terminal having a substantially plate-like shape, such as smartphones and tablets. A frequency band of radio waves used in the antenna module 100 according to the present embodiment is a frequency band higher than 6 GHz and is typically a millimeter wave band, so-called “frequency range 2 (FR2)”. The frequency band of the FR2 is from 24.25 GHz to 52.6 GHz, for example. The frequency band of radio waves used in the antenna module 100 may conform to the radio communication standard of “wireless gigabit (WiGig)” using the 60 GHz band.

Referring to FIG. 1, the communication device 10 includes the antenna module 100 and a BBIC 200 constituting a baseband signal processing circuit. The antenna module 100 includes an RFIC 110, which is an example of a feeder circuit, and an antenna device 120. The communication device 10 up-converts a signal transmitted from the BBIC 200 to the antenna module 100 into a radio frequency signal and radiates the radio frequency signal from the antenna device 120. The communication device 10 also down-converts a radio frequency signal received at the antenna device 120 and processes the signal at the BBIC 200.

FIG. 1 only illustrates the configuration corresponding to four antenna elements 121 and omits the illustration of the same configurations corresponding to other antenna elements 121 among a plurality of antenna elements (radiation electrodes) 121 constituting the antenna device 120, for the sake of simpler description. Here, FIG. 1 illustrates the example in which the antenna device 120 includes a plurality of antenna elements 121 arranged in a two-dimensional array. However, the antenna device 120 does not necessarily include a plurality of antenna elements 121 but the antenna device 120 may include a single antenna element 121. Also, a plurality of antenna elements 121 may be aligned in one-dimensional array. The present embodiment describes the example in which the antenna element 121 is a patch antenna having a substantially-square plate-like shape, but the antenna element 121 may be a dipole antenna or monopole antenna. Further, patch antennas and dipole antennas or monopole antennas may be used together as the antenna elements 121.

The RFIC 110 includes switches 111A to 111D, 113A to 113D, and 117; power amplifiers 112AT to 112DT; low noise amplifiers 112AR to 112DR; attenuators 114A to 114D; phase shifters 115A to 115D; a signal synthesizing/demultiplexing device 116; a mixer 118; and an amplifying circuit 119.

In transmitting a radio frequency signal, the switches 111A to 111D and 113A to 113D are switched to the power amplifiers 112AT to 112DT sides and the switch 117 is connected to a transmission amplifier of the amplifying circuit 119. In receiving a radio frequency signal, the switches 111A to 111D and 113A to 113D are switched to the low noise amplifiers 112AR to 112DR sides and the switch 117 is connected to a reception amplifier of the amplifying circuit 119.

A signal transmitted from the BBIC 200 is amplified in the amplifying circuit 119 and up-converted in the mixer 118. A transmission signal that is the up-converted radio frequency signal is demultiplexed into four signals in the signal synthesizing/demultiplexing device 116 and fed to mutually-different antenna elements 121 through four signal paths respectively. At this time, the directivity of the antenna device 120 can be adjusted by individually adjusting phase levels of the phase shifters 115A to 115D arranged on respective signal paths.

Reception signals which are radio frequency signals received by respective antenna elements 121 pass through four different signal paths respectively and synthesized in the signal synthesizing/demultiplexing device 116. The synthesized reception signal is down-converted in the mixer 118 and amplified in the amplifying circuit 119 to be transmitted to the BBIC 200.

The RFIC 110 is formed as one chip of integrated circuit component having the above-described circuit configuration, for example. Alternatively, devices (switch, power amplifier, low noise amplifier, attenuator, phase shifter) corresponding to each antenna element 121 in the RFIC 110 may be formed as one chip of integrated circuit component for each corresponding antenna element 121.

### (User's Holding Posture)

FIGS. 2A and 2B illustrate examples of user's holding states of the communication device 10. The communication device 10 is a smartphone, and a housing 15 thereof is composed of a case 30 and a display screen 40. When a user holds a smartphone with one hand, the communication device 10 is held in a manner such that the display screen 40, which is formed as a portion of the housing 15 and has a rectangular shape, is vertically long, as illustrated in FIG. 2A. In this state, portion on the lower side from the center in the long side direction of the housing 15 is covered with the user's hand.

When a user watches a video with a smartphone, for example, the communication device 10 is held in a manner such that the display screen 40 is horizontally long, as illustrated in FIG. 2B. In this state, corner portions on the lower side from the center in the short side direction of the housing 15 tend to be covered with the user's hands.

Communication devices having a plate-like shape, namely smartphones and tablets, have increasingly employed the configuration in which a plurality of antennas are arranged so as to improve their communication quality. On the other hand, communication devices have been increasingly required to be thinned and to have a larger screen, gradually increasing the rate of a display screen with respect to a housing. A liquid crystal panel or an organic EL panel is generally employed as a display screen of a communication device. Throughout such a display screen, conductor wirings are arranged in a lattice on the surface or inside of the screen so as to detect a position touched by a user. That is, the display screen serves as a shield for antennas radiating radio waves.

Accordingly, antennas are often arranged on end portions of a communication device or corner portions of a housing in such communication devices. However, user's hand sometimes overlaps with a position on which an antenna tends to be arranged, depending on the user's holding posture as illustrated in FIGS. 2A and 2B. This may cause the deterioration of the antenna characteristics.

Therefore, the following embodiments will describe antenna arrangements that suppress the deterioration of the antenna characteristics caused by the user's holding in consideration of user's holding postures of a communication device.

### First Embodiment

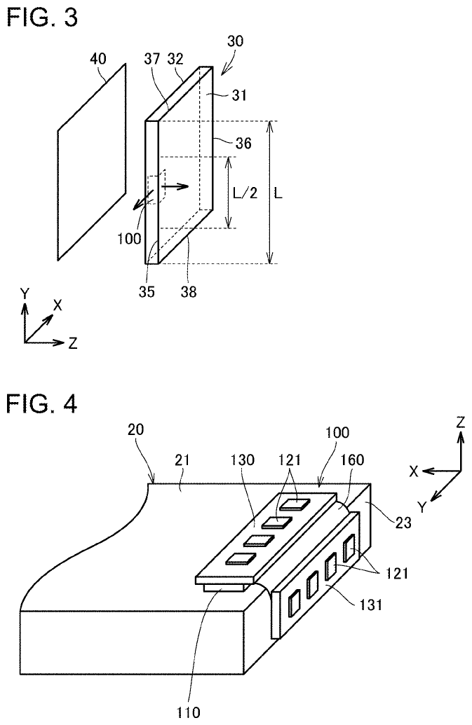

FIG. 3 is a drawing for explaining an arrangement of an antenna module 100 in a communication device according to a first embodiment. FIG. 3 omits illustration of a mounting substrate 20 to which the antenna module 100 is connected and illustrates only the case 30 and display screen 40 constituting the housing 15 of the communication device, for the sake of simpler description. FIG. 3 shows a state in which the case 30 and the display screen 40 are separated from each other.

Referring to FIG. 3, the case 30 has a plate-like shape and includes a first surface 31, not facing the display screen 40, and a second surface 32, facing the display screen. The case 30 has a substantially rectangular shape including two long sides 35 and 36 and two short sides 37 and 38. In the example of FIG. 3, sides extending in the X axis direction of the case 30 are the short sides, and sides extending in the Y axis direction are the long sides. In the first embodiment, the antenna module 100 is arranged on a position corresponding to a central portion of one long side 35 (a first long side). Here, the “central portion” in the present embodiment represents a range of L/2 length extending on both sides of the center of a long side when the length of the long side of the case 30 is L.

The detailed configuration of the antenna module 100 will be described later, but the antenna module 100 is configured to be capable of radiating radio waves in two different directions. More specifically, the antenna module 100 is configured to radiate radio waves in two directions that are a normal direction of the first surface 31 of the case 30 (the positive direction of the Z axis in FIG. 3) and a normal direction of a lateral surface of the case 30 along the long side (the first long side) on which the antenna module 100 is arranged (the negative direction of the X axis in FIG. 3).

The display screen 40 is formed on the second surface 32 side of the case 30 as described above, and there is a tendency to reduce a region for a frame portion (bezel) surrounding the display screen 40 in the housing along with screen size increase. Therefore, the antenna module 100 is arranged so that radio waves are radiated in the normal direction of the first surface 31, thus avoiding interference in radio wave radiation caused by the display screen 40.

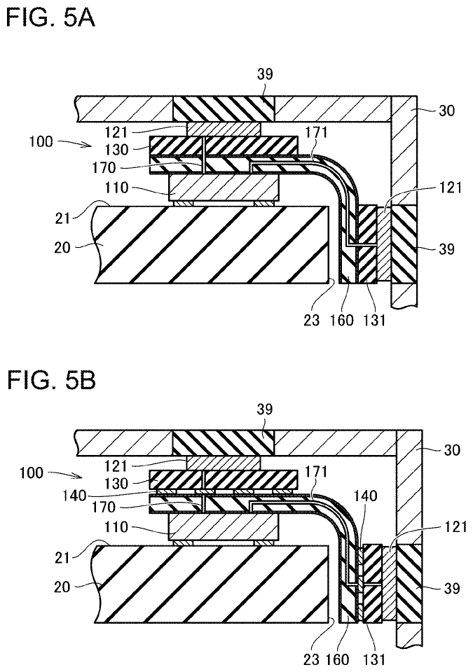

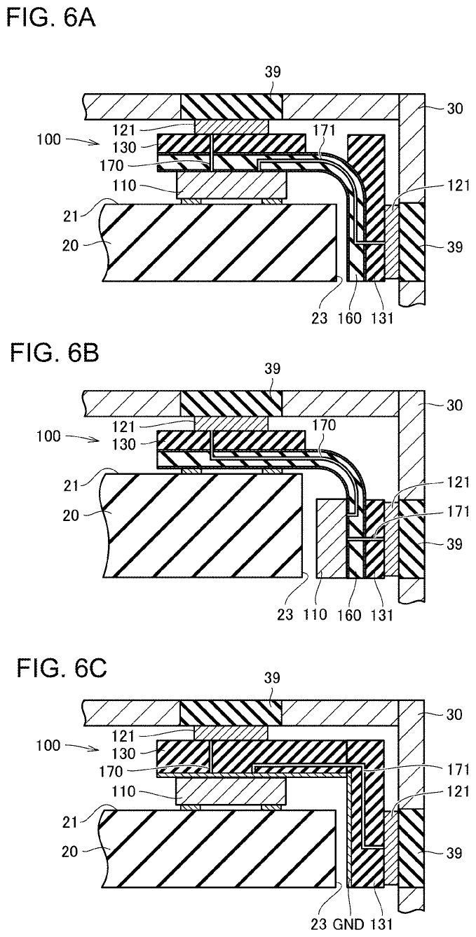

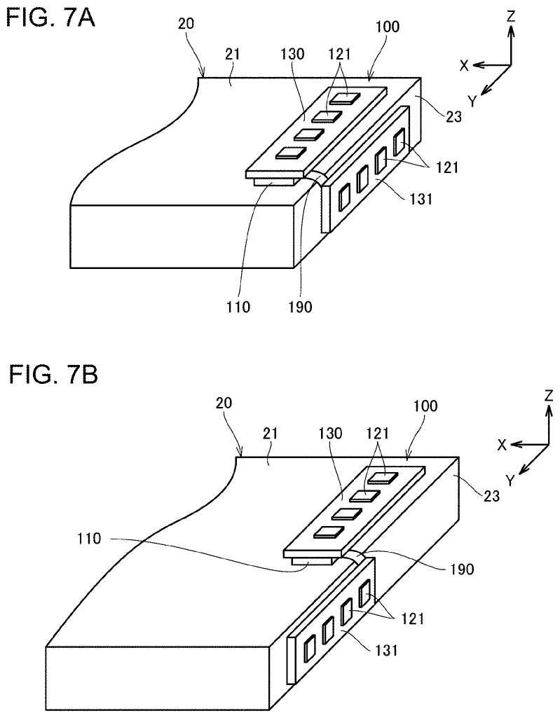

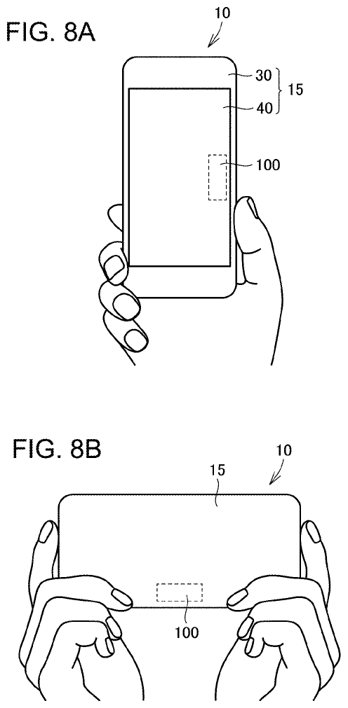

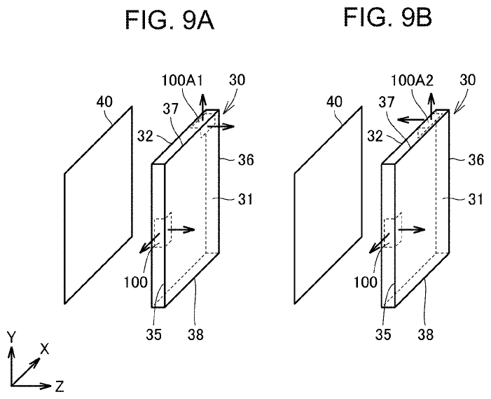

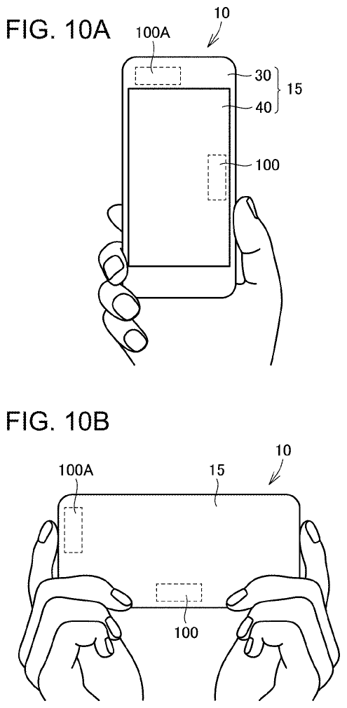

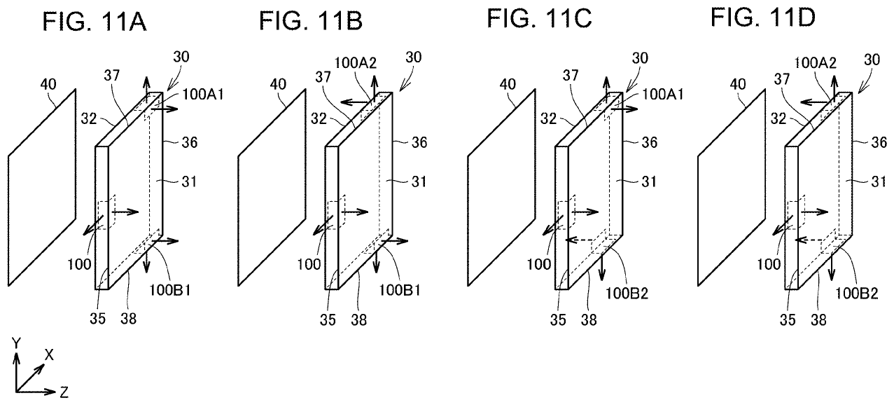

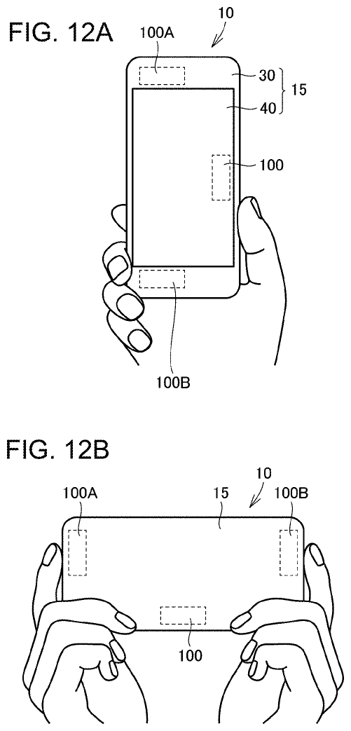

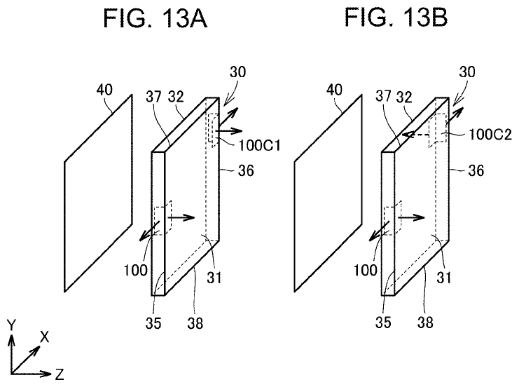

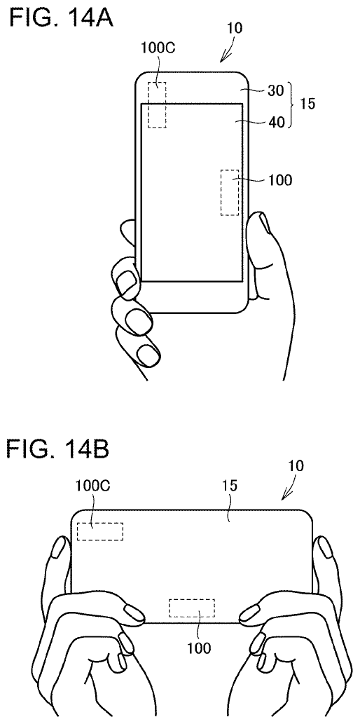

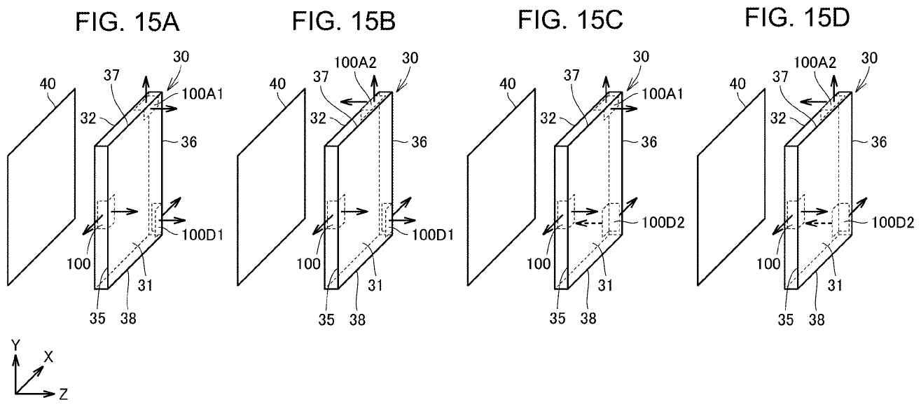

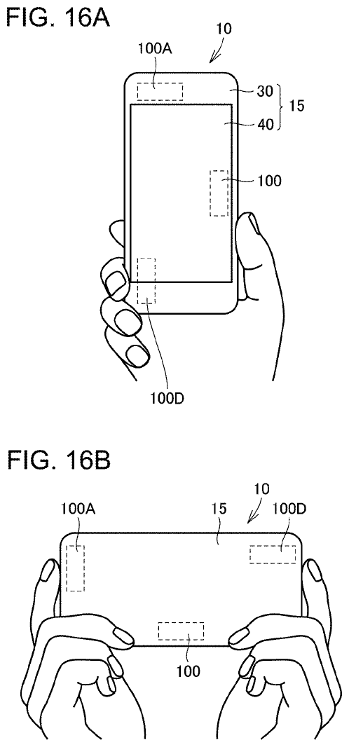

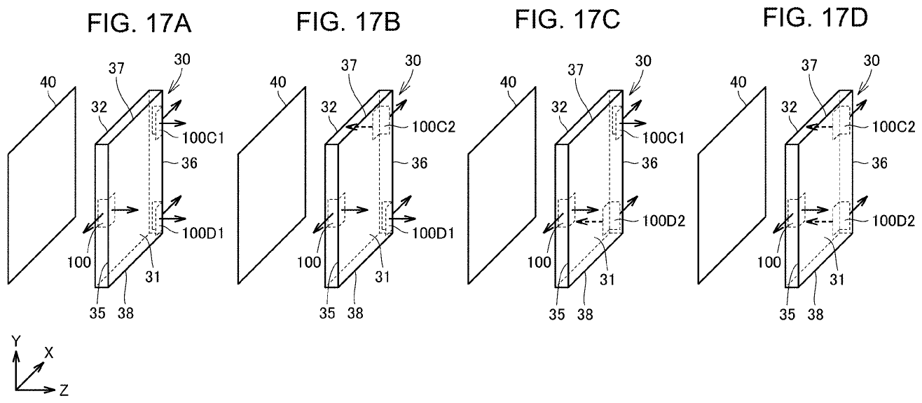

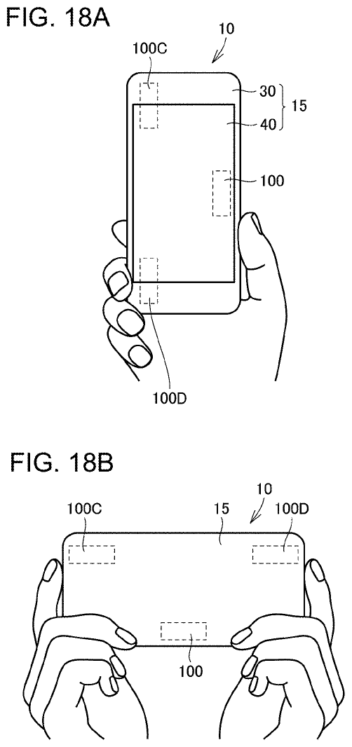

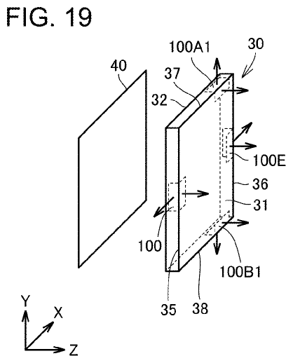

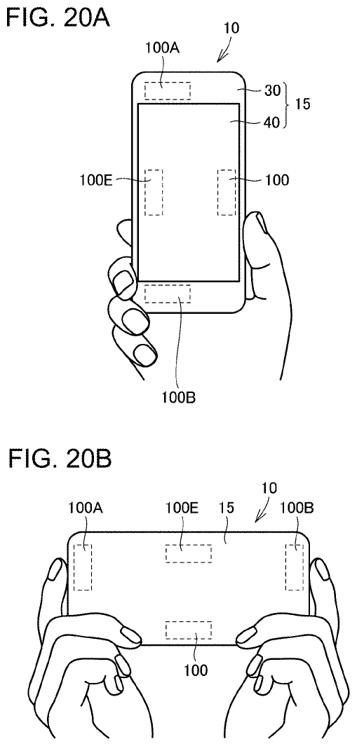

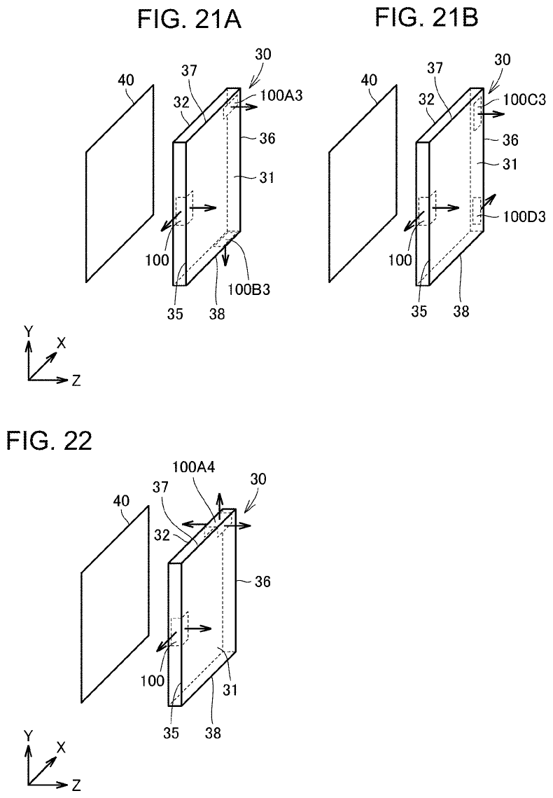

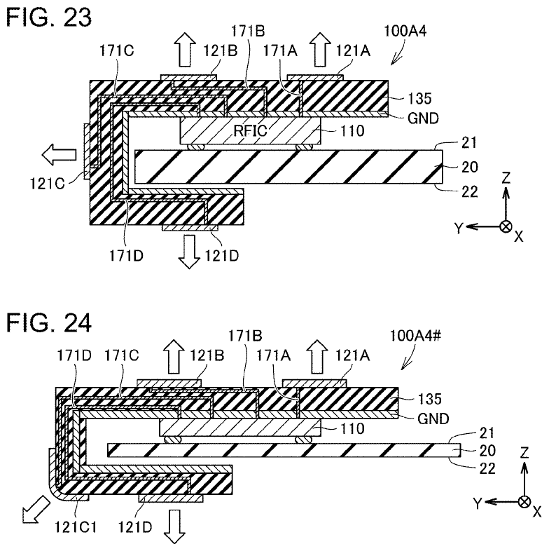

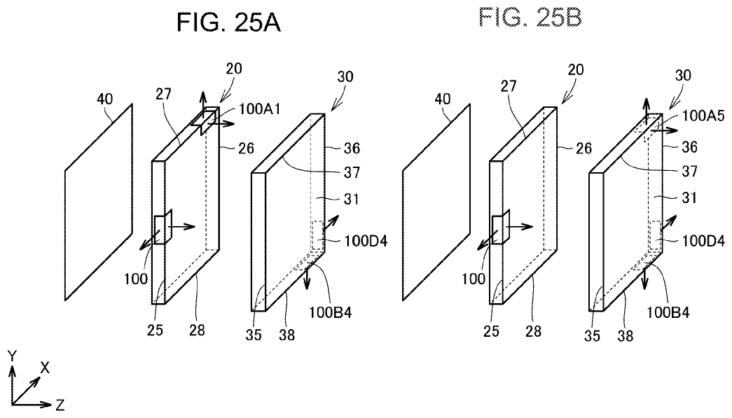

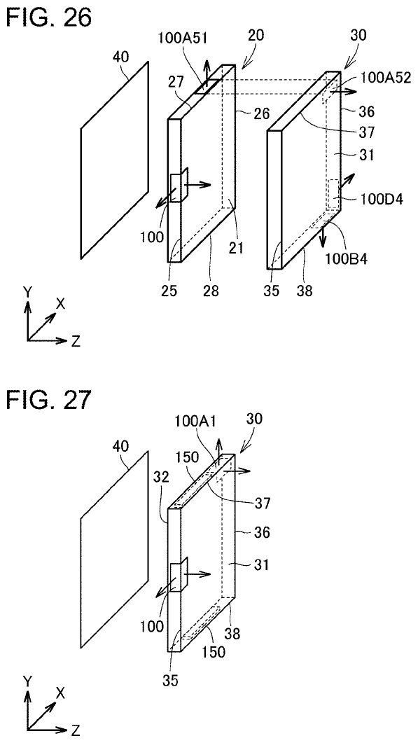

FIGS. 4, 5A and 5B are drawings for explaining the detailed configuration of the antenna module 100. FIG. 4 is a perspective view illustrating a state in which the antenna module 100 is arranged on the mounting substrate 20. Each of FIGS. 5A and 5B is a sectional view of the antenna module 100 that is accommodated in the case 30.

Referring to FIGS. 4, 5A and 5B, the antenna module 100 is arranged on a first surface 21 of the mounting substrate 20 through the RFIC 110. On the RFIC 110, dielectric substrates 130 and 131 are arranged in a manner to interpose a flexible substrate 160, which has flexibility, between the RFIC 110 and the dielectric substrates 130 and 131. Antenna elements 121 are arranged on each of the dielectric substrates 130 and 131. The dielectric substrates 130 and 131 may be bonded to the flexible substrate 160 with an adhesive (not illustrated) as illustrated in FIG. 5A or may employ the configuration in which electrodes of the substrates are solder-mounted with a solder bump 140 as illustrated in FIG. 5B. Further, the dielectric substrate 131 may have a configuration to protrude from a bent portion of the flexible substrate 160 to the dielectric substrate 130 side as illustrated in FIG. 6A.

Here, the antenna module 100 may be directly mounted on the mounting substrate 20 or may be connected to the mounting substrate 20 with a cable. Also, the RFIC 110 may be separated from the antenna module 100 to be mounted on the mounting substrate 20, and the flexible substrate 160 and the RFIC 110 may be connected with each other with a cable. Further, the antenna module 100 may be configured in a manner such that the flexible substrate 160 is directly mounted on the mounting substrate 20 and the RFIC 110 is arranged on the dielectric substrate 131 side as illustrated in FIG. 6B.

When the antenna module 100 is directly mounted on the mounting substrate 20 through the RFIC 110, the heat from the RFIC 110 is easily transferred to the mounting substrate 20, enhancing a heat radiation effect.

The antenna module 100 does not necessarily include the flexible substrate 160 as long as the antenna module 100 is capable of radiating radio waves in two different directions. As illustrated in FIG. 6C, the dielectric substrate 130 and the dielectric substrate 131 may be connected to each other in a substantially-orthogonal manner by bonding, solder-mounting, connector connection, or the like. This orthogonal arrangement makes it possible to effectively use a space in the housing.

The dielectric substrate 130 extends along the first surface 21, and the antenna elements 121 are arranged so that radio waves are radiated in the normal direction of the first surface 21 (that is, the positive direction of the Z axis in FIG. 4).

The flexible substrate 160 is bent to face from the first surface 21 to a lateral surface 23 of the mounting substrate 20, and the dielectric substrate 131 is arranged on a surface along the lateral surface 23. The antenna elements 121 are arranged on the dielectric substrate 131 so that radio waves are radiated in the normal direction of the lateral surface 23 (that is, the negative direction of the X axis in FIG. 4).

The dielectric substrates 130 and 131 and the flexible substrate 160 are substrates which are formed in a multilayer structure of resin such as epoxy and polyimide. Further, the dielectric substrates 130 and 131 and the flexible substrate 160 may be made of liquid crystal polymer (LCP) having a lower dielectric constant or fluorine resin, for example. The dielectric substrates 130 and 131 may be made of low temperature co-fired ceramics (LTCC). The dielectric substrates 130 and 131 and the flexible substrate 160 may be formed integrally.

A radio frequency signal from the RFIC 110 is supplied to the antenna elements 121 on the dielectric substrate 130 through a feeding wire 170. Further, a radio frequency signal from the RFIC 110 is supplied to the antenna elements 121 on the dielectric substrate 131 through a feeding wire 171 which passes inside the flexible substrate 160. The flexible substrate 160 is formed as a strip line or a micro strip line, for example.

The antenna elements 121 are arranged on the dielectric substrates 130 and 131 so as to face the case 30 of the housing 15. When the case 30 is made of metal, the case 30 serves as a shield with respect to radio waves radiated from the antenna elements 121. Therefore, dielectric portions 39 made of resin or the like are partially formed on portions facing the antenna elements 121. FIGS. 5A, 5B and 6 illustrate the configuration in which the antenna element 121 is in contact with the dielectric portion 39 of the case 30. However, the antenna element 121 and the dielectric portion 39 do not have to be always in contact with each other, and a gap may be formed or another substance, which can transmit radio waves, may be interposed between the antenna element 121 and the dielectric portion 39.

FIG. 4 illustrates the configuration in which the dielectric substrates 130 and 131 are arranged on the flexible substrate 160. However, the configuration may be employed in which the dielectric substrate 130 and the dielectric substrate 131 are connected with each other with a flat cable 190, for example, as illustrated in FIGS. 7A and 7B. In this configuration, the dielectric substrate 130 and the dielectric substrate 131 may be arranged so that their positions in respective extending directions (the Y axis direction) are substantially the same as each other as illustrated in FIG. 7A. Alternatively, the dielectric substrate 130 and the dielectric substrate 131 may be arranged so that their positions in the Y axis direction are relatively shifted as illustrated in FIG. 7B. The arrangement of FIG. 7A makes it possible to reduce the size and space compared to the arrangement of FIG. 7B.

Each of FIGS. 8A and 8B is a drawing for explaining an antenna-module arrangement in a state in which the communication device 10 according to the first embodiment is held by a user. In the example of FIG. 8A, the antenna module 100 is arranged on the central portion of the right long side of the display screen 40 in the state in which a user looks at the display screen 40 while holding the communication device 10 with one hand. In this example, the user's hand holding the communication device 10 does not overlap with the antenna module 100. Here, the antenna module 100 may be arranged on the central portion of the left long side of the display screen 40 in an opposite manner to FIG. 8A.

When a user holds the communication device 10 with both hands as illustrated in FIG. 8B, the user holds end portions on short sides. Accordingly, the antenna module 100 and the user's hands do not overlap with each other on the position of the antenna module 100 arranged on the central portion of the long side. Consequently, it is suppressed that the user's hands interfere with the radiation of radio waves.

Thus, an antenna module is arranged on the central portion of a long side in a communication device having a substantially rectangular shape. This configuration can suppress the deterioration of the antenna characteristics caused by the overlap between a user's hand and the antenna module, irrespective of user's holding postures. In the first embodiment, radio waves are also radiated in the lateral surface direction, so a radio-wave covering area of the communication device can be further expanded.

Further, the configuration of radiating the radio waves in two directions realizes more efficient radiation of the heat generated in an RFIC because a contact area between the antenna module and a housing is larger than the configuration of radiating the radio waves only in a single direction. This contributes to failure reduction and lifetime elongation of the device.

### Second Embodiment

The first embodiment has described the configuration in which the antenna module is arranged on the central portion of a long side of the communication device. A second embodiment will describe the configuration in which another antenna module is arranged on a short side in addition to the configuration of the first embodiment.

Each of FIGS. 9A and 9B is a drawing for explaining an antenna-module arrangement in a communication device according to the second embodiment. Referring to FIGS. 9A and 9B, in addition to the antenna module 100 (a first antenna module) arranged on a position corresponding to the long side 35 (the first long side) of the case 30, an antenna module 100A1 or an antenna module 100A2 (these are also collectively referred to as the “antenna module 100A”) is arranged on a position corresponding to the short side 37 (a first short side) of the case 30, in the communication device according to the second embodiment. The antenna module 100A corresponds to a “second antenna module” of the present disclosure.

In the example of FIG. 9A, the antenna module 100A1 is arranged on a position corresponding to the short side 37 of the case 30. The antenna module 100A1 is configured to radiate radio waves in two directions which are the normal direction of the first surface 31 (the positive direction of the Z axis in FIGS. 9A and 9B) and the normal direction of a lateral surface along the short side 37 (the positive direction of the Y axis in FIGS. 9A and 9B). The two antenna modules which are the antenna module 100 and antenna module 100A enable the communication device to radiate radio waves in three directions as a whole. Further, both of the antenna module 100 and antenna module 100A1 radiate radio waves in the normal direction of the first surface 31 (the positive direction of the Z axis in FIGS. 9A and 9B); accordingly, the intensity of radio waves in the radiation direction can be increased.

Further, in the example of FIG. 9B, the antenna module 100A2 is arranged. The antenna module 100A2 is configured to radiate radio waves in two directions which are the normal direction of the second surface 32 (the negative direction of the Z axis in FIGS. 9A and 9B) and the normal direction of the lateral surface along the short side 37 (the positive direction of the Y axis in FIGS. 9A and 9B). This configuration enables the communication device to radiate radio waves in four directions as a whole.

Each of FIGS. 9A and 9B illustrates the example in which the antenna module 100A is arranged on the position corresponding to the short side 37, but the antenna module 100A may be arranged on a position corresponding to the other short side 38. Further, in the antenna modules 100 and 100A, a dipole antenna or patch antenna, one end of which is grounded, may be arranged on a dielectric substrate on the lateral surface side so as to radiate radio waves in the Z axis direction also from antenna elements arranged on the lateral surface side.

In both examples of the antenna module 100A1 of FIG. 9A and the antenna module 100A2 of FIG. 9B, the antenna module 100A is arranged on a position close to the long side 36 on which the antenna module 100A is not arranged, rather than a position close to the long side 35 on which the antenna module 100A is arranged, along the short side 37 on which each antenna module is arranged.

Here, the antenna module 100A2 that radiates radio waves to the display screen 40 side as illustrated in FIG. 9B can be employed only when a bezel is formed around the display screen 40. The configuration of FIG. 9B cannot be employed when the occupation region of the display screen 40 is expanded for a larger screen and antenna elements on the second surface 32 side of the antenna module 100A2 are covered with the display screen 40 on the second surface 32, on which the display screen 40 of the communication device 10 is formed.

Each of FIGS. 10A and 10B is a drawing for explaining an antenna-module arrangement in a state in which the communication device 10 according to the second embodiment is held by a user.

In the example of FIG. 10A, the antenna module 100 is positioned on the central portion of the right long side of the display screen 40 and the antenna module 100A is positioned on the left end portion of the upper short side of the display screen 40, in the state in which a user looks at the display screen 40 while holding the communication device 10 with one hand. In this example, the antenna module 100A is positioned on the opposite side of user's holding position in the vertical direction (the extending direction of the long side), so the antenna module 100A does not basically overlap with the user's hand holding the communication device 10.

In the example of FIG. 10B in which a user holds the communication device 10 with both hands, the antenna module 100A is positioned on an upper end portion of a short side held by the user, so the antenna module 100A does not relatively easily overlap with the user's hands.

Thus, in a communication device having a substantially rectangular shape, the first antenna module is arranged on a central portion of a long side and the second antenna module is arranged on a position of a short side which is close to a long side on which the first antenna module is not arranged. This configuration can suppress the deterioration of the antenna characteristics caused by the user's holding and can expand the radio-wave covering area of the communication device. Further, the intensity of radio waves in a specific direction can be increased by radiating radio waves in the same direction with two antenna modules, as illustrated in FIG. 9A.

### Third Embodiment

The second embodiment has described the configuration in which an antenna module is arranged on one short side in addition to the one on the central portion of a long side of the communication device. A third embodiment will describe the configuration in which an antenna module is further arranged on another short side in addition to the configuration of the second embodiment.

Each of FIGS. 11A, 11B, 11C and 11D is a drawing for explaining an antenna-module arrangement in the communication device 10 according to the third embodiment. Referring to FIGS. 11A, 11B, 11C and 11D, in addition to the antenna module 100 (the first antenna module) arranged on the position corresponding to the long side 35 (the first long side) of the case 30 and the antenna module 100A (a second antenna module) arranged on the position corresponding to the short side 37 (the first short side), an antenna module 100B1 or an antenna module 100B2 (these are also collectively referred to as the “antenna module 100B”) is arranged on a position corresponding to another short side 38 (a second short side), in the communication device 10 according to the third embodiment. The antenna module 100B corresponds to a “third antenna module” of the present disclosure.

In the example of FIG. 11A, the antenna module 100B1 is further arranged on the position corresponding to the short side 38 of the case 30 in addition to the configuration of FIG. 9A of the second embodiment. The antenna module 100B1 is configured to radiate radio waves in two directions which are the normal direction of the first surface 31 (the positive direction of the Z axis in FIGS. 11A, 11B, 11C and 11D) and the normal direction of a lateral surface along the short side 38 (the negative direction of the Y axis in FIGS. 11A, 11B, 11C and 11D). This configuration enables the communication device to radiate radio waves in four directions as a whole. Further, as radio waves are radiated in the positive direction of the Z axis from the three antenna modules, the intensity of radio waves radiated in this direction can be increased.

The example of FIG. 11B has the configuration in which the antenna module 100B1, which is the same as that in FIG. 11A, is further arranged on the position corresponding to the short side 38 in addition to the configuration of FIG. 9B of the second embodiment. This configuration enables the communication device to radiate radio waves in five directions as a whole.

The example of FIG. 11C has the configuration in which the antenna module 100B2 is further arranged on the position corresponding to the short side 38 in addition to the configuration of FIG. 9A of the second embodiment. The antenna module 100B2 is configured to radiate radio waves in two directions which are the normal direction of the second surface 32 (the negative direction of the Z axis in FIGS. 11A, 11B, 11C and 11D) and the normal direction of the lateral surface along the short side 38 (the negative direction of the Y axis in FIGS. 11A, 11B, 11C and 11D). Here, the antenna module 100B2 can be employed only when a bezel is formed around the display screen 40. The configuration of FIG. 11C also enables the communication device to radiate radio waves in five directions as a whole, as is the case with the configuration of FIG. 11B.

The example of FIG. 11D has the configuration in which the antenna module 100B2, which is the same as that in FIG. 11C, is further arranged on the position corresponding to the short side 38 in addition to the configuration of FIG. 9B of the second embodiment. This configuration enables the communication device to radiate radio waves in five directions as a whole and can increase the intensity of radio waves radiated in the normal direction of the second surface 32 (the negative direction of the Z axis in FIGS. 11A, 11B, 11C and 11D).

The antenna module 100B is arranged on the position close to the long side 36, on which the antenna module 100 is not arranged, on the position corresponding to the short side 38, as is the case with the antenna module 100A.

Each of FIGS. 12A and 12B is a drawing for explaining an antenna-module arrangement in a state in which the communication device 10 according to the third embodiment is held by a user.

In the example of FIG. 12A, the antenna module 100 is positioned on the central portion of the right long side of the display screen 40, the antenna module 100A is positioned on the left end portion of the upper short side of the display screen 40, and further, the antenna module 100B is positioned on the left end portion of the lower short side of the display screen 40, in the state in which a user looks at the display screen 40 while holding the communication device 10 with one hand. In this example, the antenna module 100A does not basically overlap with the user's hand holding the communication device 10, as is the case with the second embodiment.

On the other hand, the antenna module 100B is on the position overlapping with the user's holding position, so the antenna characteristics of the antenna module 100B may be affected by the user's hand. However, when the user holds the communication device upside down, for example, the antenna module 100A overlaps with the user's holding position, while the antenna module 100B is positioned not to overlap with the user's hand. Thus, by arranging antenna modules on two short sides respectively, a wider covering area can be secured even when a holding direction of the communication device is inverted.

In the example of FIG. 12B in which a user holds the communication device 10 with both hands, the antenna module 100A and the antenna module 100B are respectively positioned on upper end portions of two short sides held by the user. That is, both of the antenna module 100A and the antenna module 100B are arranged on positions on which the antenna modules 100A and 100B do not relatively easily overlap with the user's hands.

Thus, in addition to the first antenna module which is arranged on the central portion of one long side, the second antenna module and the third antenna module are respectively arranged on two short sides. This configuration can suppress the deterioration of the antenna characteristics caused by the user's holding and can expand the radio-wave covering area of the communication device. Further, a plurality of antenna modules radiate radio waves in the same direction, being able to increase the intensity of radio waves in the specific direction.

### Fourth Embodiment

The second embodiment and the third embodiment have described the configuration in which an antenna module is also arranged on a short side/short sides in addition to an antenna module arranged on the central portion of a long side of the communication device. A fourth embodiment will describe the configuration in which an antenna module is also arranged on another long side in addition to an antenna module arranged on the central portion of one long side of a communication device.

Each of FIGS. 13A and 13B is a drawing for explaining an antenna-module arrangement in the communication device 10 according to the fourth embodiment. Referring to FIGS. 13A and 13B, in addition to the antenna module 100 (the first antenna module) arranged on the position corresponding to the long side 35 (the first long side) of the case 30, an antenna module 100C1 or an antenna module 100C2 (these are also collectively referred to as the “antenna module 100C”) is arranged on a position corresponding to another long side 36 (a second long side), in the communication device 10 according to the fourth embodiment. The antenna module 100C corresponds to a “fourth antenna module” of the present disclosure.

In the example of FIG. 13A, the antenna module 100C1 is arranged on the long side 36 of the case 30. The antenna module 100C1 is configured to radiate radio waves in two directions which are the normal direction of the first surface 31 (the positive direction of the Z axis in FIGS. 13A and 13B) and the normal direction of a lateral surface along the long side 36 (the positive direction of the X axis in FIGS. 13A and 13B). This configuration enables the communication device to radiate radio waves in three directions as a whole.

In the example of FIG. 13B, the antenna module 100C2 is arranged. The antenna module 100C2 is configured to radiate radio waves in two directions which are the normal direction of the second surface 32 (the negative direction of the Z axis in FIGS. 13A and 13B) and the normal direction of the lateral surface along the long side 36 (the positive direction of the X axis in FIGS. 13A and 13B). This configuration enables the communication device to radiate radio waves in four directions as a whole. Here, the antenna module 100C2 can be employed only when portion of a bezel formed on the short side 37 side has a sufficient width from the display screen 40 or portion of the bezel formed on the long side 36 side has a sufficient width from the display screen 40 so that the antenna module 100C2 and the display screen 40 do not overlap with each other.

Each of FIGS. 14A and 14B is a drawing for explaining an antenna-module arrangement in a state in which the communication device 10 according to the fourth embodiment is held by a user.

In the example of FIG. 14A, the antenna module 100 is positioned on the central portion of the right long side of the display screen 40 and the antenna module 100C is positioned on the left end portion of the upper short side of the display screen 40, in the state in which a user looks at the display screen 40 while holding the communication device 10 with one hand. In this example, the antenna module 100C is positioned on the opposite side of user's holding position in the vertical direction (the extending direction of the long side), so the antenna module 100C does not basically overlap with the user's hand holding the communication device 10, as is the case with the antenna module 100A in FIG. 10A.

In the example of FIG. 14B in which a user holds the communication device 10 with both hands, the antenna module 100C is positioned on an upper end portion of the short side held by the user in a manner to extend along a long side. Accordingly, it is harder to overlap with the user's hand compared to the example of FIG. 10B.

Thus, in a communication device having a substantially rectangular shape, the first antenna module is arranged on a central portion of one long side and the fourth antenna module is arranged on another long side. This configuration can avoid a state in which the antenna modules and user's hand overlap with each other. This configuration can suppress the deterioration of the antenna characteristics caused by the user's holding and can expand the radio-wave covering area of the communication device. Further, two antenna modules radiate radio waves in the same direction in the example of FIG. 13A, being able to increase the intensity of radio waves in the specific direction.

In the examples illustrated in FIGS. 13A, 13B, 14A and 14B, the antenna module 100C1 is arranged not on the center of the long side 36 but on a position close to the short side 37 (the first short side), on the long side 36. However, the antenna module 100C1 may be arranged on a position close to the short side 38 (the second short side) or may be arranged on the central portion of the long side 36 as the antenna module 100.

### Fifth Embodiment

A fifth embodiment will describe the configuration in which antenna modules are also arranged on another long side and one short side respectively in addition to an antenna module on a central portion of one long side of a communication device. In other words, the fifth embodiment has the configuration obtained by combining the second embodiment with the fourth embodiment.

Each of FIGS. 15A, 15B, 15C and 15D is a drawing for explaining an antenna-module arrangement in the communication device 10 according to the fifth embodiment. Referring to FIGS. 15A, 15B, 15C and 15D, in addition to the antenna module 100 (the first antenna module) arranged on the position corresponding to the long side 35 (the first long side) of the case 30, the antenna module 100A (the second antenna module) is arranged on the position corresponding to the short side 37, and an antenna module 100D1 or an antenna module 100D2 (these are also collectively referred to as the “antenna module 100D”) is further arranged on the position corresponding to another long side 36 (the second long side), in the communication device 10 according to the fifth embodiment.

The antenna module 100D is arranged on a position close to the short side 38, on which the antenna module 100A is not arranged, on the position corresponding to the long side 36. In the fifth embodiment, the antenna module 100D corresponds to a “fourth antenna module” of the present disclosure.

In the example of FIG. 15A, the antenna module 100D1 is further arranged on the position, which is close to the short side 38, on the position corresponding to the long side 36 of the case 30, in addition to the configuration of FIG. 9A according to the second embodiment. The antenna module 100D1 is configured to radiate radio waves in two directions which are the normal direction of the first surface 31 (the positive direction of the Z axis in FIGS. 15A, 15B, 15C and 15D) and the normal direction of the lateral surface along the long side 36 (the positive direction of the X axis in FIGS. 15A, 15B, 15C and 15D). This configuration enables the communication device to radiate radio waves in four directions as a whole. Further, three antenna modules radiate radio waves in the same direction, the positive direction of the Z axis; therefore, the intensity of radio waves radiated in this direction can be increased.

The example of FIG. 15B has the configuration in which the antenna module 100D1 is further arranged in addition to the configuration of FIG. 9B according to the second embodiment. This configuration enables the communication device to radiate radio waves in five directions as a whole.

In the example of FIG. 15C, the antenna module 100D2 is further arranged on the position, which is close to the short side 38, on the position corresponding to the long side 36, in addition to the configuration of FIG. 9A of the second embodiment. The antenna module 100D2 is configured to radiate radio waves in two directions which are the normal direction of the second surface 32 (the negative direction of the Z axis in FIGS. 15A, 15B, 15C and 15D) and the normal direction of the lateral surface along the long side 36 (the positive direction of the X axis in FIGS. 15A, 15B, 15C and 15D). This configuration also enables the communication device to radiate radio waves in five directions as a whole.

The example of FIG. 15D has the configuration in which the antenna module 100D2 is further arranged in addition to the configuration of FIG. 9B according to the second embodiment. This configuration also enables the communication device to radiate radio waves in five directions as a whole and can increase the intensity of radio waves radiated in the normal direction of the second surface 32 (the negative direction of the Z axis in FIGS. 15A, 15B, 15C and 15D).

Each of FIGS. 16A and 16B is a drawing for explaining an antenna-module arrangement in a state in which the communication device 10 according to the fifth embodiment is held by a user.

In the example of FIG. 16A, the antenna module 100 is positioned on the central portion of the right long side of the display screen 40, the antenna module 100A is positioned on the left end portion of the upper short side of the display screen 40, and further, the antenna module 100D is positioned on the lower end portion of the left long side of the display screen 40, in the state in which a user looks at the display screen 40 while holding the communication device 10 with one hand. When the user holds the communication device 10 with one hand, the antenna module 100D overlaps with the user's holding position, so the antenna characteristics may be affected by the user's hand. However, when the communication device is held upside down, the antenna module 100D is positioned not to overlap with the user's hand, as is the case with FIG. 12A of the third embodiment. Thus, a wide covering area can be secured even when a holding direction of the communication device is inverted.

In the example of FIG. 16B in which a user holds the communication device 10 with both hands, the antenna module 100A is positioned on an upper end portion of one short side held by the user in a manner to extend along the short side, and the antenna module 100D is positioned on an upper end portion of the other short side in a manner to extend along a long side. That is, both of the antenna module 100A and the antenna module 100D are arranged on positions on which the antenna modules 100A and 100D do not relatively easily overlap with the user's hands.

Thus, by employing the antenna-module arrangement of the fifth embodiment, the deterioration of the antenna characteristics caused by the user's holding can be suppressed and the radio-wave covering area of the communication device can be expanded. Further, a plurality of antenna modules radiate radio waves in the same direction, being able to increase the intensity of radio waves in the specific direction.

### Sixth Embodiment

The fourth embodiment has described the configuration in which an antenna module is also arranged on another long side in addition to an antenna module arranged on a central portion of one long side of the communication device. A sixth embodiment will describe the configuration in which two antenna modules are arranged on another long side.

Each of FIGS. 17A, 17B, 17C and 17D is a drawing for explaining an antenna-module arrangement in the communication device 10 according to the sixth embodiment. Referring to FIGS. 17A, 17B, 17C and 17D, in addition to the antenna module 100 (the first antenna module) arranged on the position corresponding to the long side 35 (the first long side) of the case 30, two antenna modules which are the antenna module 100C and the antenna module 100D are arranged on the position corresponding to another long side 36 (the second long side), in the communication device 10 according to the sixth embodiment.

The antenna module 100C is the same as the antenna module described in the fourth embodiment, and the antenna module 100C is arranged not on the center of the long side 36 but on a position close to the short side 37, on the position corresponding to the long side 36. Further, the antenna module 100D is the same as the antenna module arranged on the position corresponding to the long side 36 in the fifth embodiment, and the antenna module 100D is arranged not on the center of the long side 36 but on a position close to the short side 38, on the position corresponding to the long side 36. In the sixth embodiment, the antenna module 100C corresponds to the “fourth antenna module” of the present disclosure, and the antenna module 100D corresponds to a “fifth antenna module” of the present disclosure.

The example of FIG. 17A employs the configuration obtained by adding the antenna module 100D1 of the fifth embodiment to the configuration of FIG. 13A of the fourth embodiment. This configuration enables the communication device to radiate radio waves in three directions as a whole. Further, three antenna modules radiate radio waves in the same direction, the positive direction of the Z axis; therefore, the intensity of radio waves radiated in this direction can be increased. Further, two antenna modules radiate radio waves also in the positive direction of the X axis, being able to increase the intensity of radio waves radiated in this direction.

The example of FIG. 17B employs the configuration obtained by adding the antenna module 100D1 of the fifth embodiment to the configuration of FIG. 13B of the fourth embodiment. This configuration enables the communication device to radiate radio waves in four directions as a whole.

The example of FIG. 17C employs the configuration obtained by adding the antenna module 100D2 of the fifth embodiment to the configuration of FIG. 13A of the fourth embodiment. This configuration also enables the communication device to radiate radio waves in four directions as a whole.

The example of FIG. 17D employs the configuration obtained by adding the antenna module 100D2 of the fifth embodiment to the configuration of FIG. 13B of the fourth embodiment. This configuration enables the communication device to radiate radio waves in four directions as a whole and can increase the intensity of radio waves radiated in the normal direction of the second surface 32 (the negative direction of the Z axis in FIGS. 17A, 17B, 17C and 17D).

Each of FIGS. 18A and 18B is a drawing for explaining an antenna-module arrangement in a state in which the communication device 10 according to the sixth embodiment is held by a user.

In the example of FIG. 18A, the antenna module 100 is positioned on the central portion of the right long side of the display screen 40, the antenna module 100C is positioned on the upper end portion of the left long side of the display screen 40 along this long side, and further, the antenna module 100D is positioned on the lower end portion of the left long side of the display screen 40 along this long side, in the state in which a user looks at the display screen 40 while holding the communication device 10 with one hand. In this example, the antenna module 100C does not overlap with the user's hand holding the communication device 10. On the other hand, the antenna module 100D is on the position overlapping with the user's hand, so the antenna characteristics may be affected. However, when the user holds the communication device upside down, the antenna module 100D is positioned not to overlap with the user's hand. Thus, by arranging antenna modules on both end portions along the other long side, a wide covering area can be secured even when a holding direction of the communication device is inverted.

In the example of FIG. 18B in which a user holds the communication device 10 with both hands, the antenna module 100C and the antenna module 100D are respectively positioned on upper end portions of two short sides held by the user in a manner to extend along a long side. That is, both of the antenna module 100C and the antenna module 100D are arranged on positions on which the antenna modules 100C and 100D do not relatively easily overlap with the user's hands.

Thus, in addition to the first antenna module which is arranged on the central portion of one long side, the fourth antenna module and the fifth antenna module are arranged on the other long side. This configuration can suppress the deterioration of the antenna characteristics caused by the user's holding and can expand the radio-wave covering area of the communication device. Further, a plurality of antenna modules radiate radio waves in the same direction, being able to increase the intensity of radio waves in the specific direction.

### Seventh Embodiment

A seventh embodiment will describe the configuration in which antenna modules are respectively arranged on four sides of a communication device.

FIG. 19 is a drawing for explaining an antenna-module arrangement in the communication device 10 according to the seventh embodiment. Referring to FIG. 19, in addition to the antenna module 100 (the first antenna module) arranged on the position corresponding to the long side 35 (the first long side) of the case 30, an antenna module 100E (a fourth antenna module) is arranged on the position corresponding to another long side 36, and further, the antenna module 100A1 (the second antenna module) and antenna module 100B1 (a third antenna module) are arranged on the positions respectively corresponding to the short sides 37 and 38, in the communication device 10 according to the seventh embodiment.

The antenna module 100A1 and antenna module 100B1 are arranged not on the centers of respective short sides but on positions which are close to the long side 36, in respective short sides. The antenna module 100E is arranged on the central portion of the long side 36. This configuration enables the communication device to radiate radio waves in four directions as a whole. Further, four antenna modules radiate radio waves in the normal direction of the first surface 31 (the positive direction of the Z axis of FIG. 19), being able to increase the intensity of radio waves in this direction.

In FIG. 19, each of the antenna modules 100A1, 100B1, and 100E is configured to radiate radio waves in the normal direction of the first surface 31 and the normal direction of the corresponding lateral surface of the case 30. However, the configuration may be employed in which at least one of the antenna modules 100A1, 100B1, and 100E is arranged to radiate radio waves in the normal direction of the second surface 32 as the antenna modules 100A2 and 100B2 so as to radiate radio waves in the positive and negative directions of X, Y, and Z (six directions) by the four antenna modules. Also, the configuration may be employed in which part of the antenna modules 100A1, 100B1, and 100E radiates radio waves in only one direction.

Each of FIGS. 20A and 20B is a drawing for explaining an antenna-module arrangement in a state in which the communication device 10 according to the seventh embodiment is held by a user.

In the example of FIG. 20A, the antenna module 100 is positioned on the central portion of the right long side of the display screen 40 and the antenna module 100E is positioned on the central portion of the right long side, in the state in which a user looks at the display screen 40 while holding the communication device 10 with one hand. Further, the antenna module 100A is positioned on the left end portion of the upper short side of the display screen 40, and the antenna module 100B is positioned on the left end portion of the lower short side of the display screen 40. In this example, the antenna modules other than the antenna module 100B do not overlap with the user's hand.

FIG. 20B is a drawing illustrating a state in which a user holds the communication device 10 with both hands. In this state, the antenna modules 100 and 100E arranged along the long sides are positioned between the user's both hands holding the communication device 10 and accordingly, the antenna modules 100 and 100E do not overlap with the user's hands. Further, the antenna modules 100A and 100B arranged on the upper end portions of the short sides are also on positions on which the antenna modules 100A and 100B do not relatively easily overlap with the user's hands.

Thus, in addition to the first antenna module which is arranged on a central portion of one long side, the second antenna module and the third antenna module are respectively arranged on two short sides and the fourth antenna module is further arranged on a central portion of the other long side. This configuration can suppress the deterioration of the antenna characteristics caused by the user's holding and can expand the radio-wave covering area of the communication device. Further, a plurality of antenna modules radiate radio waves in the same direction, being able to increase the intensity of radio waves in the specific direction.

### Eighth Embodiment

The second to seventh embodiments have described the configuration in which each antenna module is capable of radiating radio waves in two directions. However, in terms of the antenna modules other than the antenna module 100, the number of radio-wave radiating directions does not have to be two. An eighth embodiment will describe the configuration in which the number of radio-wave radiating directions of antenna modules other than the antenna module 100 is one.

FIGS. 21A and 21B is a drawing for explaining an antenna-module arrangement in the communication device 10 according to the eighth embodiment. The example illustrated in FIG. 21A employs the configuration obtained by replacing the antenna module 100A1 arranged along the short side 37 with an antenna module 100A3 and replacing the antenna module 100B1 arranged on the short side 38 with an antenna module 100B3, in the example of the third embodiment in which the antenna modules are arranged on two short sides (FIG. 11A). The radiating direction of the antenna module 100A3 is only the normal direction of the first surface 31 and the radiating direction of the antenna module 100B3 is only the normal direction of the lateral surface along the short side 38.

The example illustrated in FIG. 21B employs the configuration obtained by replacing the antenna module 100C1 with an antenna module 100C3 and replacing the antenna module 100D1 with an antenna module 100D3, in the example of the sixth embodiment in which two antenna modules 100C1 and 100D1 are arranged on the other long side 36 (FIG. 17A). The radiating direction of the antenna module 100C3 is only the normal direction of the first surface 31 and the radiating direction of the antenna module 100D3 is only the normal direction of the lateral surface along the long side 36.

Even when the number of radiating directions of antenna modules other than the antenna module 100 is one as described above, the antenna-module arrangement as that illustrated in each of FIGS. 21A and 21B suppresses overlap between the antenna modules and user's hand, being able to suppress the deterioration of the antenna characteristics caused by the user's holding.

Here, in the eighth embodiment, the number of radiating directions of all the antenna modules other than the antenna module 100 is not necessarily one, and it is enough that the number of radiating directions of at least one of the antenna modules is one. Also, in the communication devices of other examples described in the second to seventh embodiments, the number of radio-wave radiating directions of any one of the antenna modules 100A to 100E may be set to one.

### Ninth Embodiment

The eighth embodiment has described the configuration in which the number of radio-wave radiating directions of antenna modules other than the antenna module 100 in the communication device 10 is set to one. A ninth embodiment will describe the configuration in which the number of radio-wave radiating directions of antenna modules other than the antenna module 100 is set to three.

FIG. 22 is a drawing for explaining an antenna-module arrangement in the communication device 10 according to the ninth embodiment. The communication device 10 according to the ninth embodiment has the configuration obtained by replacing the antenna module 100A1 arranged on the short side 37 with an antenna module 100A4, in the configuration described in the second embodiment in which antenna modules are arranged on the central portion on the position corresponding to the long side 35 and on the position corresponding to one short side 37. The number of radio-wave radiating directions of the antenna module 100A4 is three. More specifically, the antenna module 100A4 is configured to radiate radio waves in three directions which are the normal direction of the first surface 31 of the case 30 (the positive direction of the Z axis of FIG. 22), the normal direction of the second surface 32 (the negative direction of the Z axis of FIG. 22), and the normal direction of the lateral surface along the short side 37 (the positive direction of the Y axis of FIG. 22).

Here, the antenna modules 100B to 100E which are described in the second to seventh embodiments and are arranged on the positions corresponding to the long side 36 and/or short side 38 may be configured to radiate radio waves in three directions as is the case with the antenna module 100A4.

FIG. 23 is a sectional view of the first example of the antenna module illustrated in FIG. 22. The antenna module 100A4 includes a dielectric substrate 135, an RFIC 110, antenna elements 121A to 121D, and feeding wires 171A to 171D.

The antenna module 100A4 is arranged on the first surface 21 of the mounting substrate 20 through the RFIC 110.

The dielectric substrate 135 is bent to have a substantially C-shape section. In the dielectric substrate 135, the antenna elements 121A and 121B are arranged on a surface whose normal direction is the positive direction of the Z axis of FIG. 23, the antenna element 121C is arranged on a surface whose normal direction is the positive direction of the Y axis, and the antenna element 121D is arranged on a surface whose normal direction is the negative direction of the Z axis. A ground electrode GND is formed inside the dielectric substrate 135, and the dielectric substrate 135 forms a strip line in the example of FIG. 23. A radio frequency signal from the RFIC 110 is supplied to the antenna elements 121A to 121D through the feeding wires 171A to 171D respectively.

This configuration realizes radiation of radio waves in three different directions. Here, the dielectric substrate 135 in the antenna module 100A4 may have the configuration obtained by combining a flexible substrate with a dielectric substrate as described in FIGS. 5A and 5B.

FIG. 24 is a sectional view of a second example of the antenna module of FIG. 22. An antenna module 100A4# in the second example is different from the antenna module 100A4 of FIG. 23 in that the antenna element 121C is arranged on a portion facing a lateral surface of the mounting substrate 20 in the dielectric substrate 135 in the antenna module 100A4 while an antenna element 121C1 is arranged on a corner portion of the dielectric substrate 135 in the antenna module 100A4#.

When the communication device 10 is further thinned, the case may be generated where a region on a surface whose normal direction is the positive direction of the Y axis of FIG. 24 is reduced in size and an antenna element cannot be arranged. In such a case, an antenna element may be bent and arranged on a corner portion of the dielectric substrate 135 as the antenna module 100A4# of FIG. 24. Accordingly, radio waves are radiated in an oblique direction from the antenna element 121C1.

Thus, at least one of antenna modules other than the first antenna module in the communication device according to the second to seventh embodiments is configured to radiate radio waves in three directions. This configuration can suppress the deterioration of the antenna characteristics caused by the user's holding and can further expand the radio-wave covering area of the communication device.

### Tenth Embodiment

A tenth embodiment will describe the configuration in which part of antenna modules is arranged on the mounting substrate 20 and the rest of the antenna modules are arranged on the case 30.

Each of FIGS. 25A and 25B is a drawing for explaining an example of an antenna-module arrangement in the communication device according to the tenth embodiment. Here, FIGS. 25A and 25B and FIG. 26, which will be described later, illustrate the mounting substrate 20 having a rectangular plate-like shape for the sake of simpler description. However, the real mounting substrate 20 has a more complex shape as a notch is formed in a part, for example. In the example of FIG. 25A, the antenna module 100 is arranged on a long side 25 of the mounting substrate 20 and the antenna module 100A1 is arranged on a short side 27. On the other hand, the antenna module 100D4 and the antenna module 100B4 are arranged on inner surfaces of the case 30 in which the mounting substrate 20 is accommodated.

Further, FIG. 25B employs the configuration in which an antenna module 100A5 corresponding to the antenna module 100A1, which is capable of radiating radio waves in two directions in FIG. 25A, is further arranged on an inner surface of the case 30.

An antenna module capable of radiating radio waves in two directions may be configured so that part of the antenna module is arranged on the mounting substrate 20 and the rest portion is arranged on the case 30.

FIG. 26 is a drawing illustrating an example of the configuration in which an antenna module is partially arranged on the case 30. FIG. 26 illustrates the configuration in which a first portion 100A51 is arranged on the short side 27 of the mounting substrate 20 and a second portion 100A52 is arranged on an inner surface of the case 30 in an antenna module corresponding to the antenna module 100A1 of FIG. 25A. The first portion 100A51 radiates radio waves in the positive direction of the Y axis and the second portion 100A52 radiates radio waves in the positive direction of the Z axis. The first portion 100A51 and the second portion 100A52 are connected with each other with a flat cable, for example.

In terms of the positional relation between the first portion 100A51 and the second portion 100A52, the first portion 100A51 and the second portion 100A52 may be arranged so that their positions are mutually shifted in the extending direction of the antenna module as illustrated in FIG. 7B.

This flexible antenna-module arrangement enhances flexibility in designing the whole communication device.

### Eleventh Embodiment

As described above, the antenna modules 100 and 100A to 100E in the above-described embodiments are antenna modules applicable to radio waves in a frequency band higher than 6 GHz. On the other hand, a communication device sometimes uses radio waves in a frequency band lower than or equal to 6 GHz (“frequency range 1 (FR1)”), which is used in the third generation partnership project (3GPP), in a combined manner. The frequency band of FR1 is from 450 MHz to 6 GHz, for example.

FIG. 27 is a drawing for explaining an example of an antenna-module arrangement in the communication device 10 according to an eleventh embodiment. FIG. 27 illustrates the configuration obtained by providing antenna modules 150 for FR1 to the configuration of the second embodiment illustrated in FIG. 9A. In the eleventh embodiment, the antenna module 150 corresponds to a “sixth antenna module” of the present disclosure.

More specifically, the antenna modules 150 for FR1 are arranged on positions corresponding to the lateral surfaces along the short sides 37 and 38 of the case 30. In this configuration, the antenna module 150 for FR1 is preferably arranged not to overlap with the antenna module 100A1 for FR2.

Here, the arrangement of the antenna modules 150 in FIG. 27 is merely an example, and the antenna modules 150 may be arranged on positions corresponding to other lateral surfaces of the case 30 or arranged on the first surface 31 side. Further, the antenna module for FR2 may be arranged in an arbitrary manner among the second to tenth embodiments.

Arranging the antenna modules for FR1 in addition to the antenna modules for FR2 realizes application to radio waves in a plurality of frequency bands.

In the above-described embodiments, each antenna element may be an antenna element for single polarization which outputs radio waves in a single polarization direction or an antenna element for dual polarization which outputs radio waves in two polarization directions.

It should be noted that the embodiments disclosed in this specification are merely examples and are not restrictive in all aspects. The scope of the present disclosure is indicated by the scope of claims rather than the description of the embodiments described above, and is intended to include all modifications within the meaning and scope equivalent to the scope of the claims.
10 communication device
15 housing
20 mounting substrate
21, 31 first surface
22, 32 second surface
23 lateral surface
25, 26, 35, 36 long side
27, 28, 37, 38 short side
30 case
39 dielectric portion
40 display screen
100, 100A to 100E, 150 antenna module
110 RFIC
111A to 111D, 113A to 113D, 117 switch
112AR to 112DR low noise amplifier
112AT to 112DT power amplifier
114A to 114D attenuator
115A to 115D phase shifter
116 signal synthesizing/demultiplexing device
118 mixer
119 amplifying circuit
120 antenna device
121, 121A to 121D antenna element
130, 131, 135 dielectric substrate
140 solder bump
160 flexible substrate
170, 171, 171A to 171D feeding wire
190 flat cable
200 BBIC
GND ground electrode

1. A communication device comprising:
a first antenna module comprising at least one antenna, the antenna module being configured to radiate radio waves having a frequency greater than 6 GHz;
a mounting substrate that has a plate-like shape and to which the first antenna module is connected; and
a housing that comprises a display screen, the display screen being on a portion of the housing, and the housing accommodating the mounting substrate, wherein:
the housing has a first surface and a second surface opposed to the first surface, and as seen in a plan view in a normal direction of the first surface, the housing has a substantially rectangular shape including a first long side, a second long side, a first short side, and a second short side,
the display screen is on the second surface, and
the first antenna module is along the first long side of the housing and is configured to radiate radio waves in the normal direction of the first surface and in a normal direction of a lateral surface along the first long side.

2. The communication device according to claim 1, wherein the first antenna module is on a central portion of the first long side.

3. The communication device according to claim 1, further comprising:
a second antenna module comprising at least one antenna, the second antenna module being along the first short side.

4. The communication device according to claim 3, wherein the second antenna module is along the first short side, and is closer to the second long side than to the first long side.

5. The communication device according to claim 3, further comprising:
a third antenna module comprising at least one antenna, the third antenna module being along the second short side.

6. The communication device according to claim 5, wherein the third antenna module is closer to the second long side than to the first long side.

7. The communication device according to claim 1, further comprising:
a fourth antenna module comprising at least one antenna, the fourth antenna module being along the second long side.

8. The communication device according to claim 7, further comprising:
a fifth antenna module comprising at least one antenna, the fifth antenna module being along the second long side, wherein:
the fourth antenna module is closer to the first short side than to the second short side, and
the fifth antenna module is closer to the second short side than to the first short side.

9. The communication device according to claim 3, wherein the second antenna module is configured to radiate a radio wave in the normal direction of the first surface, a normal direction of the second surface, or a normal direction of a lateral surface along the third short side.

10. The communication device according to claim 3, wherein the second antenna module is configured to radiate a radio wave in the normal direction of the first surface or a normal direction of the second surface, and a normal direction of a lateral surface along the third short side.

11. The communication device according to claim 3, wherein the second antenna module is configured to radiate a radio wave in the normal direction of the first surface, a normal direction of the second surface, and a normal direction of a lateral surface along the third short side.

12. The communication device according to claim 3, wherein:
the first antenna module is on the mounting substrate, and
the second antenna module is on the housing.

13. The communication device according to claim 3, wherein:
the first antenna module is on the mounting substrate, and
the second antenna module includes a first portion that is on the mounting substrate and a second portion that is on the housing.

14. The communication device according to claim 3, wherein the second antenna module is configured to radiate radio waves in a frequency band greater than 6 GHz.

15. The communication device according to claim 1, further comprising:
a sixth antenna module comprising at least one antenna, the sixth antenna module being along the first short side or the second short side,
wherein the sixth antenna module is configured to radiate radio waves in a frequency band of 6 GHz or less.
